(19) United States
(12) Patent Application Publication
(10) Pub. No.: US 2006/0223506 A1
(43) Pub. Date: Oct. 5, 2006

(54) Method of communication between a server and a mobile terminal

(75) Inventors: Veronique Daurensan, Antony (FR); Guy Mathieu, Orsay (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/268,626

(22) Filed: Nov. 8, 2005

(30) Foreign Application Priority Data
Nov. 9, 2004 (FR) 04 52 569

(51) Int. Cl. H04Q 7/38

(52) U.S. Cl. 455/414.1

(57) ABSTRACT

A mobile terminal sends to a server at least one image showing a model of the appearance of a person, as well as other items of information such as the type of an event to be attended or information about the person attending, and the server sends back to the mobile advice as to how the person can modify his or her own appearance.

The invention relates to the field of methods of communication between a server and a mobile terminal, the server giving the user of the mobile terminal advice as to how the user can modify his or her own appearance, and also to the field of servers and mobile terminals adapted to implement said methods of communication. The modification to the appearance of the user of the mobile terminal may relate in particular to hairstyle and/or style of dress and/or style of makeup.

In the prior art, as described for example in the following documents such as international patent application WO 2004/036478, Japanese patent abstracts JP 2002159338, JP 2002015056 or JP 2001273457, methods of communication between a server and a mobile terminal are provided that relate above all to the hairstyle of the user of the mobile terminal, in which the server advises the user of the portable terminal about hairstyle or gives the user the option of simulating hairstyles. A drawback of those methods is that they are not sufficiently adapted either to the user or to the specific situation in which the user is to be found when seeking advice from the server.

The invention provides an improved method in which two additional items of information relating firstly to the user him- or herself and secondly to the specific situation in which the user is to be found are communicated by the mobile terminal to the server, which then makes use of those items of information to give advice that is better adapted to the user and the user's situation.

The invention provides a method of communication between a server and a mobile terminal, the method comprising: a step of the mobile terminal sending at least one image to the server showing a model of the appearance of a person; a step of the server analyzing the image as sent; an association step of associating the analyzed image with at least one item of information relating to advice for the user of the mobile terminal; and a step of sending to the mobile terminal the information associated with the image, or at least some of the information associated with the image; the method being characterized in that: the mobile terminal provides the server with at least two additional items of information for assisting the server in analyzing the image, said additional items of information including the type of event that is to be attended by the user of the mobile terminal and information concerning objective data about the user of the mobile terminal; the server makes use of said additional information when performing the association step; and the information concerning advice to the user of the mobile terminal includes advice to the user of the mobile terminal for making the user's appearance resemble that of the model.

The invention also provides a mobile terminal comprising: a sender device for sending to a server at least one image representing a model of the appearance of a person; and a receiver device for receiving from a server an item of information associated by the server with the image and relating to advice to the user of the mobile terminal or at least some of the information associated by a server with the image and relating to advice to the user of the mobile terminal; the terminal being characterized in that the sender device is adapted to provide a server with at least two additional items of information for assisting the server in analyzing the image, said additional items including the type of event that is to be attended by the user of the mobile terminal and information concerning objective data about the user of the mobile terminal.

The invention also provides a server comprising: a receiver device for receiving at least one image showing a model of the appearance of a person as sent by a mobile terminal; an analyzer device for analyzing the image received and for associating the analyzed image with at least one item of information relating to advice to a user of a mobile terminal; and a sender device for sending to a mobile terminal the information associated with the image or at least some of the information associated with the image; the server being characterized in that: the receiver device is adapted to receive from a mobile terminal at least two additional items of information for assisting the server in analyzing the image, including a type of event which a user of a mobile terminal is likely to attend and information concerning objective data about a user of a mobile terminal; the analyzer device is adapted to use said additional information during the association step; and the information for sending by the server's sender device to a mobile terminal comprises advice to a user of a mobile terminal to make the user's appearance resemble that of the model.

The invention can better understood and other features and advantages will appear on reading the following description and the accompanying drawing, given by way of example and in which:

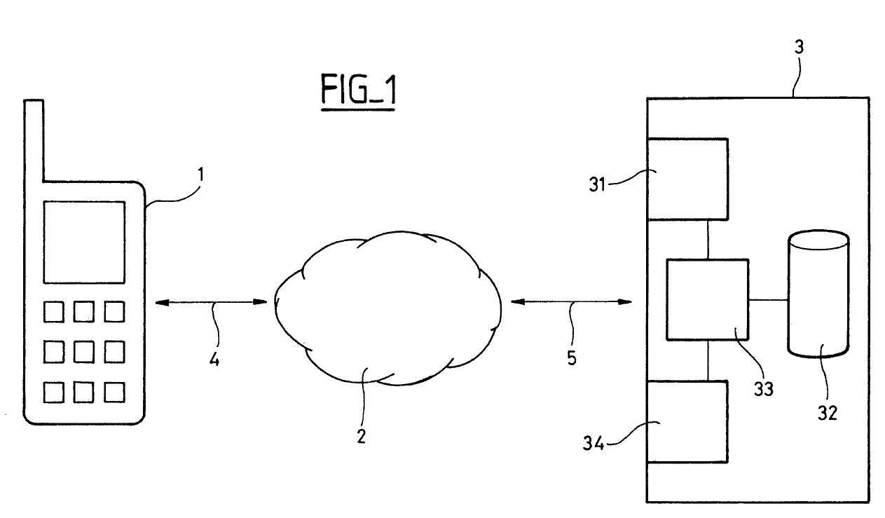

FIG. 1 is a diagram of an example of a system including a server and a mobile terminal, and implementing the method of communication of the invention.

Preferably, a record or history of previous consultations of the server by the user is stored, and a summary of this record is prepared by the server, and the server uses the summary for performing the association step. Thus, the more the user uses the service, the richer the record and the greater the ability of the server to propose a service that is effective and adapted to the user, which means that after a certain length of time the service is likely to give the user full satisfaction. In a preferred embodiment, the summary includes the type of event attended most frequently by the user, the type of model selected most frequently by the user, and the version of the information relating to objective data about the user of the mobile terminal that has been received the most recently by the server from the mobile terminal. The server can thus have an accurate idea of the type of user both concerning objective characteristics, e.g. defining external appearance such as, in particular: weight, height, age, or position such as profession, and concerning subjective characteristics, in particular about tastes. Keeping a record in the server can also make it possible to take account simultaneously of the user's habits and of the changes in the user's behavior over time, so as to enable users to change appearance in keeping with their own personalities and in such a manner as to avoid shocking others by changes that are too sudden or that are unsuitable. The record can also list various types of event and classify them as a function of other people involved in the event so as to avoid behavior that is too identical, such as the same outfit during another meeting with the same people, or too different, such as an outfit that is completely out of keeping with an earlier outfit from one meeting to another with the same people.

Preferably, the objective data comprises at least one or more or all of the following characteristics: age, height, weight, profession, photo. More generally, the objective data enables the server to examine the extent to which the tastes of the user can be satisfied without leading to any major trouble for the user: for example to advise the user not to wear an outfit which, given the objective data concerning the user and the type of event the user is about to attend, would make the user completely ridiculous in the eyes of other people attending the event.

The step of sending from the mobile terminal to the server is preferably performed using the multimedia messaging service (MMS).

The step of the server sending to the mobile terminal can be performed, for example, via the short message service (SMS). Nevertheless, the step of the server sending to the mobile terminal is preferably implemented via a voice message so that the user gets more of the impression of receiving personalized advice as opposed to receiving broadcast information.

FIG. 1 is a diagram showing an example of a system including a server and a mobile terminal and implementing the method of communication of the invention. The system comprises a mobile terminal 1 which is preferably a mobile telephone, a network 2 which may be of the Internet type, for example, and a server 3. The connection 4 connecting the mobile terminal 1 to the network 2 is preferably a connection of the general packet radio service (GPRS) type. The connection 5 connecting the network 2 to the server 3 is preferably a connection of the asymmetric data subscriber line (ADSL) type.

The server 3 includes a receiver module 31 for receiving information supplied by the user of the mobile terminal 1, the receiver module 31 being connected to the network 2, a database 32 storing the records of various users, an analyzer device 33 enabling advice to be drawn up for the user, and a network interface 34 enabling messages containing questions and answers to be exchanged over the network 2 between the server 3 and the mobile terminal 1 in such a manner as to refine the content of the advice provided by the server 3 to the user of the mobile terminal 1. Single-headed arrows represent transfers of information, while double-headed arrows indicate that information can be exchanged as opposed to a mere transfer of information.

An example of the operation of the above-described system is described below. The information provided by the user of the mobile terminal 1 comprises in particular the type of event that is to be attended by the user, information relating to objective data concerning the user, and an example showing the appearance of a person the user would like to resemble. This information is sent by the mobile terminal 1 over the network 2 via the connection 4; the network 2 brings the information to the server 3 via the connection 5. The receiver module 31 receives said information and delivers it to the analyzer device 33 which evaluates the information by consulting the user's record as contained in the database 32. On the basis of this evaluation, the analyzer device 33 can either directly establish advice to be sent via the interface 34 over the network 2 to reach the mobile terminal 1, or else can begin by entering into a dialog with the mobile terminal 1 involving one or more groups of questions and answers passing via the interface 34 and the network 2. In one embodiment, the receiver module 31 and the interface 34 can be combined as a single device for establishing the link between the server 3 and the network 2 via the connection 5. The analyzer device 33 may be accompanied by, or may even be replaced by, a human expert for performing the evaluation step and/or the step of preparing advice for the user.

What is claimed is:

1. A method of communication between a server (3) and a mobile terminal (1), the method comprising:
a step of the mobile terminal sending to the server at least one image showing a model of the appearance of a person;
a step of the server analyzing the image as sent;
an association step of associating the analyzed image with at least one item of information relating to advice to the user of the mobile terminal; and
a step of sending to the mobile terminal the item of information associated with the image, or at least some of the information associated with the image;
the method being characterized in that:
the mobile terminal provides the server with at least two additional items of information for assisting the server in analyzing the image, said additional items of information including the type of event that is to be attended by the user of the mobile terminal and an item of information relating to objective data about the user of the mobile terminal;
the server makes use of said additional item of information when performing the association step; and
the item of information relating to advice to the user of the mobile terminal includes advice to the user of the mobile terminal for making the user's appearance resemble that of the model.

2. A method according to claim 1, characterized in that a record of earlier consultations with the server by the user is stored, in that a summary of said record is drawn up by the server, and in that the server uses this summary in order to perform the association step.

3. A method according to claim 2, characterized in that the summary comprises the type of event attended most frequently by the user, the type of model selected most frequently by the user, and the version of the information relating to objective data about the user of the mobile terminal that has been received the most recently by the server.

4. A method according to claim 1, characterized in that the objective data comprise at least one or more or all of the following characteristics: age, height, weight, profession, photo.

5. A method according to claim 1, characterized in that the model of the appearance of a person is a model of a hairstyle.

6. A method according to claim 1, characterized in that the model of the appearance of a person is a model of a style of dress.

7. A method according to claim 1, characterized in that the model of the appearance of a person is a model of a style of makeup.

8. A method according to claim 1, characterized in that the step of sending from the mobile terminal to the server is implemented via an MMS.

9. A method according to claim 1, characterized in that the step of sending from the server to the mobile terminal is implemented via an SMS.

10. A method according to claim 1, characterized in that the step of sending from the server to the mobile terminal is implemented via a voice message.

11. A mobile terminal comprising:
a sender for sending to a server at least one image representing a model of the appearance of a person; and
a receiver for receiving from a server an item of information associated by the server with the image and relating to advice to the user of the mobile terminal, or at least some of the information associated by a server with the image and relating to advice to the user of the mobile terminal;
the terminal being characterized in that the sender is adapted to provide a server with at least two additional items of information for assisting the server in analyzing the image, said additional items including the type of event that is to be attended by the user of the mobile terminal and information relating to objective data about the user of the mobile terminal.

12. A server comprising:
a receiver for receiving at least one image showing a model of the appearance of a person as sent by a mobile terminal;
an analyzer for analyzing the image received and for associating the analyzed image with at least one item of information relating to advice to a user of a mobile terminal; and
a sender for sending to a mobile terminal the information associated with the image or at least some of the information associated with the image;
the server being characterized in that:
the receiver is adapted to receive from a mobile terminal at least two additional items of information for assisting the server in analyzing the image, including a type of event which a user of a mobile terminal is likely to attend and information relating to objective data about a user of a mobile terminal;
the analyzer is adapted to use said additional information during the association step; and
the information for sending by the server's sender to a mobile terminal comprises advice to a user of a mobile terminal to make the user's appearance resemble that of the model.
